(19) United States
(12) Patent Application Publication
(10) Pub. No.: US 2014/0098401 A1
(43) Pub. Date: Apr. 10, 2014

(54) PRINT JOB MANAGEMENT APPARATUS

(71) Applicant: RISO KAGAKU CORPORATION, Tokyo (JP)

(72) Inventor: Tomoki MATSUMURA, Ibaraki (JP)

(73) Assignee: RISO KAGAKU CORPORATION, Tokyo (JP)

(21) Appl. No.: 14/043,249

(22) Filed: Oct. 1, 2013

(30) Foreign Application Priority Data
Oct. 4, 2012 (JP) 2012-221971

(51) Int. Cl. G06F 3/12

(52) U.S. Cl. CPC G06F 3/1257
USPC 358/1.15

(57) ABSTRACT

A print job management apparatus includes a sending section configured to receive a mail including an address of a user designated as a destination and an attached file, and send the mail to the user designated as the destination, a user information storage section configured to store therein the address and a print necessity flag indicating whether the attached file needs to be printed in association with each other as user information for each user, a judgment section configured to judge whether the attached file needs to be printed for the user designated as the destination of the mail on a basis of the user information stored in the user information storage section, and a job generation section configured to generate a print job of the attached file for the user judged as requiring a printing of the attached file by the judgment section.

### CROSS REFERENCE TO RELATED APPLICATION

This application is based upon and claims the benefit of priority from the prior Japanese Patent Application No. 2012-221971, filed on Oct. 4, 2012, the entire contents of which are incorporated herein by reference.

### BACKGROUND

1. Technical Field

The present invention relates to a print job management apparatus that generates and manages print jobs.

2. Related Art

Generally, in order for members participating in a meeting to utilize a distributed document, the distributed document is sent to the members by e-mails, or the file thereof is shared among the members in many cases.

Japanese Patent Application Publication No. 2010-3218 describes a technique relating to a document review assistance device used, in a situation where multiple reviewers review a document, to assist work for compiling review results of the document from the multiple reviewers.

Japanese Patent No. 4665504 proposes a document review assistance device configured to assist multiple reviewers to review a review comment attached to an electronic document by electronic means via a network.

### SUMMARY

The document review assistance devices described in Japanese Patent Application Publication No. 2010-3218 and Japanese Patent No. 4665504 display review results on monitors. Some of users, however, desire to print out the review result on a paper medium directly rather than checking the review result on the monitor screen. Accordingly, the preferable reading style varies from user to user.

An object of the present invention is to provide a print job management apparatus capable of making a reading style changed depending on a user.

A print job management apparatus accordance with some embodiments includes a sending section configured to receive a mail including an address of a user designated as a destination and an attached file, and send the mail to the user designated as the destination, a user information storage section configured to store therein the address and a print necessity flag indicating whether the attached file needs to be printed in association with each other as user information for each user, a judgment section configured to judge whether the attached file needs to be printed for the user designated as the destination of the mail on a basis of the user information stored in the user information storage section, and a job generation section configured to generate a print job of the attached file for the user judged as requiring a printing of the attached file by the judgment section. [0010]

According to the foregoing configuration, whether or not to generate a print job of an attached file can be switched over depending on a user, and thereby the reading style of the attached file can be changed from user to user.

A print job management apparatus in accordance with some embodiments includes a sending section configured to receive a mail including an address of a user designated as a destination, an attached file, and group identification information identifying a group to which the attached file belongs, and send the mail to the user designated as the destination, a user information storage section configured to store therein the address and a print necessity flag in association with each other as user information for each user, the print necessity flag indicating whether an attached file belonging to the group needs to be printed for each group identified by the group identification information, a judgment section configured to judge whether the attached file needs to be printed for the user designated as the mail destination on a basis of the user information stored in the user information storage section, and a job generation section configured to generate a print job of the attached file for the user judged as requiring a printing of the attached file by the judgment section.

According to the foregoing configuration, each user is allowed to change the reading style of attached files among the groups to which the attached files belong.

### BRIEF DESCRIPTION OF DRAWINGS

FIG. 1 is a functional configuration diagram of an image formation system including a print job management apparatus according to an embodiment of the present invention.

FIG. 2 illustrates an example of user information stored in a user information storage section of a storage of the print job management apparatus in the image formation system according to the embodiment of the present invention.

FIG. 3 illustrates an example of user authentication information stored in the user information storage section of the storage of the print job management apparatus in the image formation system according to the embodiment of the present invention.

FIG. 4 is a sequence diagram illustrating a processing procedure of a mail sending process in the image formation system according to the embodiment of the present invention.

FIG. 5 illustrates an example of a compose mail window displayed on a screen of a terminal.

FIG. 6 is a sequence diagram illustrating a processing procedure of a print job generation process in the image formation system according to the embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present invention are described in detail with reference to the drawings.

An embodiment of the present invention is described by taking as an example an image formation system including multiple terminals configured to send and receive mails and a print job management apparatus connected to the multiple terminals via a network and configured to generate and manage print jobs based on mails sent from the terminals and to perform printing processes based on the print jobs.

### Functional Configuration of Image Formation System

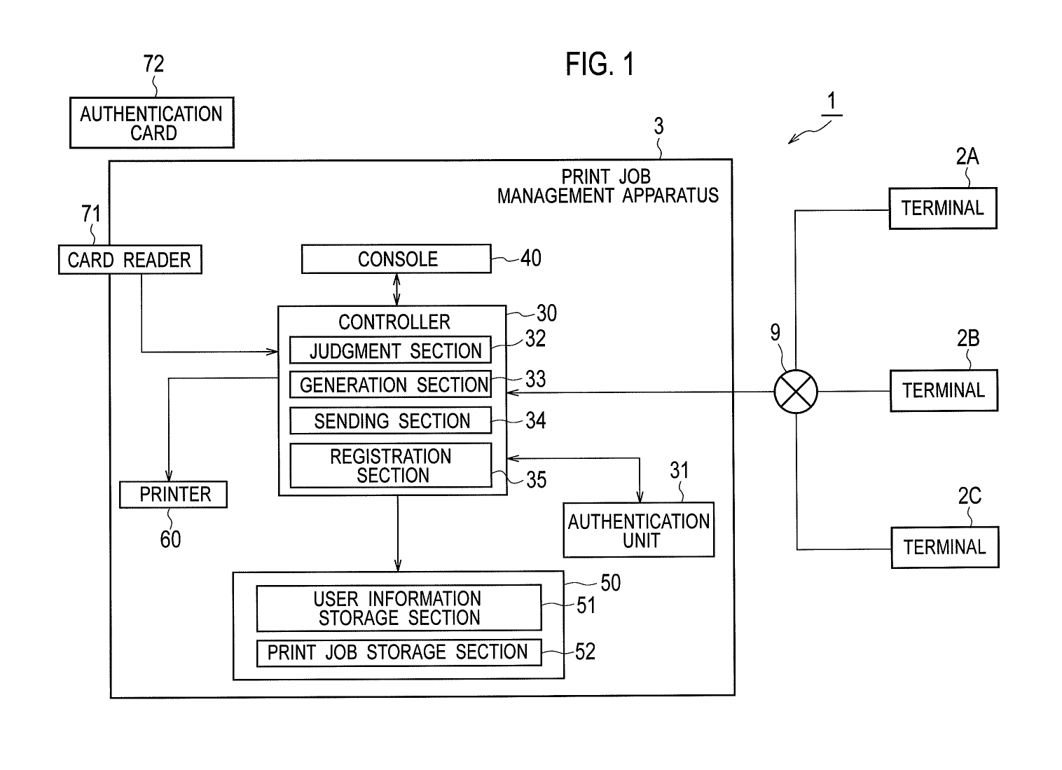

FIG. 1 is a functional configuration diagram illustrating a functional configuration of an image formation system 1 including a print job management apparatus 3 according to the embodiment of the present invention.

As illustrated in FIG. 1, the image formation system 1 includes the print job management apparatus 3 and terminals 2 (2A, 2B, 2C) connected to the print job management apparatus 3 via a network 9. Since the terminal 2A, the terminal 2B and the terminal 2C have the same configuration, the description herein is provided by using the terminal 2A as an example.

The terminal 2A sets the mail address of a destination and sends a mail.

The print job management apparatus 3 makes color print on a print medium cut in a predetermined size on the basis of a print job by, for example, ejecting inks of totally four colors of cyan (c), magenta (M), yellow (Y) and black (K) from inkjet heads.

The print job management apparatus 3 includes a controller 30, an authentication unit 31, a console 40, a storage 50, a printer 60, a card reader 71 and an authentication card 72.

The console 40 includes a display-input panel (not illustrated) and various kinds of operational keys such as a start key for starting reading, printing and other operations, a stop key for stopping reading, printing and the other operations, and ten keys for inputting the number of sheets to be printed or the like (none of these keys are illustrated). The console 40 provides the controller 30 with an operational signal based on a user operation.

The display-input panel of the console 40 includes a transparent pressure-sensitive or electrostatic touch panel arranged on the front side and a liquid display panel arranged on the back side of the touch panel and configured to display various kinds of display windows (none of both panels are illustrated). A user can perform various setting operations by directly touching the front surface of the touch panel with his/her finger or the like while viewing the display window on the liquid display panel. In addition, the user can also input a password into a password input window displayed on the display-input panel.

The storage 50 includes, as storage areas, a user information storage section 51 and a print job storage section 52.

In the user information storage section 51, an address and print necessity flags for respective groups based on group identification information are stored in association with each other as user information for each user. The print necessity flags each indicate whether an attached file belonging to the corresponding group needs to be printed or not.

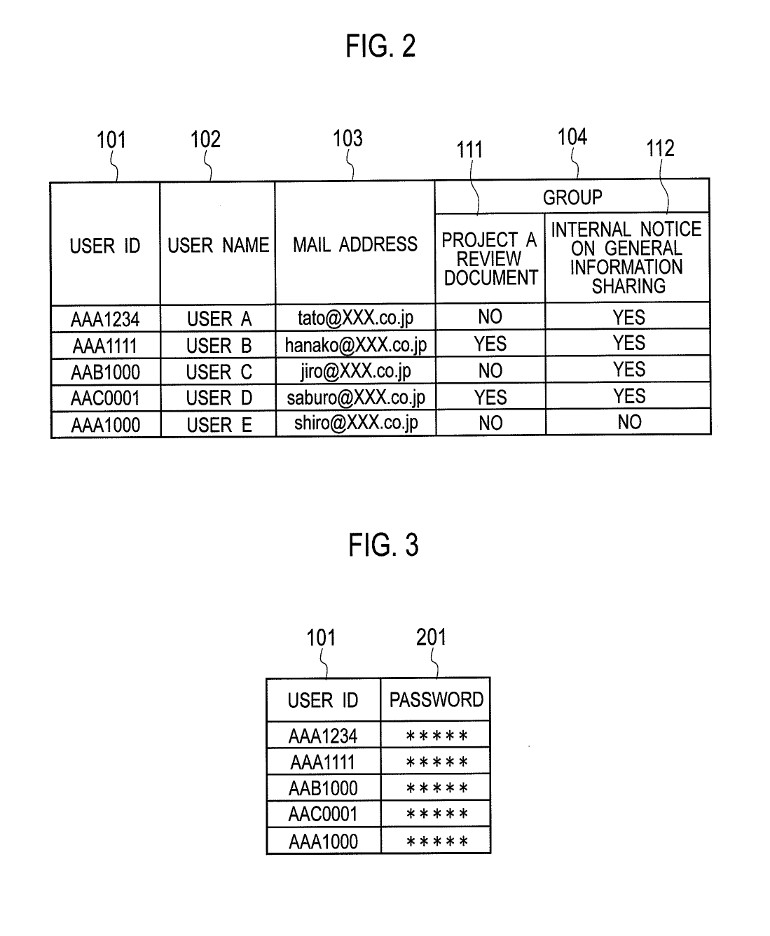

FIG. 2 illustrates an example of the user information stored in the user information storage section 51 of the storage 50 of the print job management apparatus 3 in the image formation system 1 according to the embodiment of the present invention.

As illustrated in FIG. 2, in the user information storage section 51, a column name “user ID” (reference numeral 101), a column name “user name” (reference numeral 102), a column name “mail address” (reference numeral 103) and a column name “group” (reference numeral 104) are stored in association with each other as the user information.

In the group 104, project A review document 111 and internal notice on general information sharing 112 are stored as the group identification information for identifying which group each file belongs to.

The user information is inputted by a user operating the display-input panel of the console 40 or operating any of the terminals 2A to 2C, for example, and is stored in the user information storage section 51 of the storage 50 in the print job management apparatus 3.

In the group 104, the print necessity flag of “YES” or “NO” is stored for each user and for each of the groups such as the project A review document 111 and the internal notice on general information sharing 112, where “YES” indicates that the print job needs to be generated and “NO” indicates that the print jog does not need to be generated.

In the user information storage section 51, a user ID and a password are stored in association with each other as user authentication information.

FIG. 3 illustrates an example of the user authentication information stored in the user information storage section 51 of the storage 50 of the print job management apparatus 3 in the image formation system 1 according to the embodiment of the present invention.

As illustrated in FIG. 3, in the user information storage section 51, a column name “user ID” (reference numeral 101) and a column name “password” (reference numeral 201) are stored in association with each other as the user authentication information.

Returning to FIG. 1, the print job storage section 52 stores print jobs generated by the controller 30.

The printer 60 includes inkjet heads of totally four colors of cyan (c), magenta (M), yellow (Y) and black (K) and makes color print on a print medium cut in a predetermined size by ejecting the four colors of inks from the respective inkjet heads.

The card reader 71 is a non-contact reader, and reads a card ID (user ID) stored in the authentication card 72 placed near the card reader 71.

The authentication card 72 is a card where the card ID is stored and is held by the user.

The controller 30 performs central control of the print job management apparatus 3. The controller 30 includes, as its functional blocks, a judgment section 32, a generation section 33, a sending section 34 and a registration section 35.

When a mail having a group designated therein and having a file attached thereto is sent to the mail address of a destination user, the judgment section 32 judges whether the attached file needs to be printed or not for the user designated as the mail destination on the basis of the user information.

When the judgment section 32 judges that the file belonging to a certain group needs to be printed for the destination user, the generation section 33 generates the print job based on the file attached to the sent mail.

When the judgment section 32 judges that the file belonging to the group needs to be printed for the destination user, the sending section 34 sends the destination user the mail sent from the sender and also a mail indicating whether the print job is generated or not by the generation section 33. On the other hand, when the judgment section 32 judges that the file belonging to the group does not need to be printed for the destination user, the sending section 34 sends the destination user the mail sent from the sender.

The registration section 35 registers and updates the user information stored in the user information storage section 51 or the user authentication information stored in the user information storage section 51 in the storage 50 when the user inputs the user information or the user authentication information by operating the display-input panel of the console 40 or operating any of the terminals 2A to 2C.

Upon receipt of an authentication request for the user ID from any of the terminals 2A to 2C, the authentication unit 31 authenticates the authentication-requested user ID based on the user authentication information stored in the user information storage section 51 of the storage 50.

Upon receipt of an authentication request from the console 40, the authentication unit 31 authenticates the user ID read by the card reader 71, based on the user authentication information stored in the user information storage section 51 of the storage 50.

### Operations of Image Formation System

Next, operations of the image formation system 1 are described.

The image formation system 1 mainly performs a mail sending process and a print job generation process. Thus, these processes are described below in detail.

### Mail Sending Process

The mail sending process in the image formation system 1 is described.

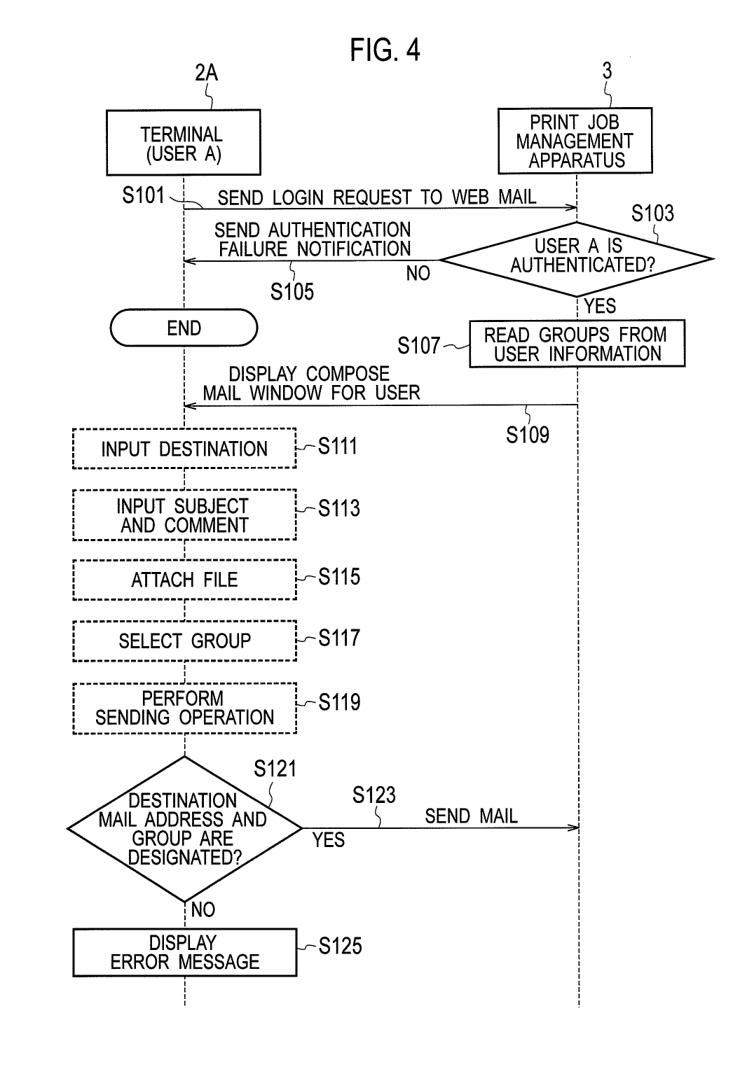

FIG. 4 is a sequence diagram illustrating a processing procedure of the mail sending process in the image formation system 1. The description herein is provided by using an example where the user A operating the terminal 2A sends a mail via the print job management apparatus 3 to a user B operating the terminal 2B.

As illustrated in FIG. 4, by operating the terminal 2A, the user A sends a login request to a web mail from the terminal 2A to the print job management apparatus 3 via the network 9 (step S101). Here, the web mail is an electronic mail client of a web application to be accessed through a web browser and is implemented by a https service or the like provided by the print job management apparatus 3.

When the login to the web mail is requested in step S101, the authentication unit 31 of the print job management apparatus 3 determines whether or not to authenticate the user A (step S103). Specifically, the authentication unit 31 judges whether or not the user ID and the password of the user A transmitted in the login request from the terminal 2A match the user ID and the password in the user authentication information stored in the user information storage section 51 of the storage 50.

When the authentication unit 31 determines not to authenticate the user A in step S103 (in the case of NO), the sending section 34 sends an authentication failure notification to the terminal 2A (step S105).

On the other hand, when the authentication unit 31 determines to authenticate the user A in step S103 (in the case of YES), the sending section 34 reads all the groups from the user information stored in the user information storage section 51 of the storage 50 (step S107). In the example illustrated in FIG. 2, the sending section 34 reads two pieces of group identification information of the “project A review document” and the “internal notice on general information sharing.”

Subsequently, via the https service, the sending section 34 sends the two read pieces of group identification information and causes a compose mail window 300 for the authenticated user A to be displayed on the web browser launched by the terminal 2A (step S109).

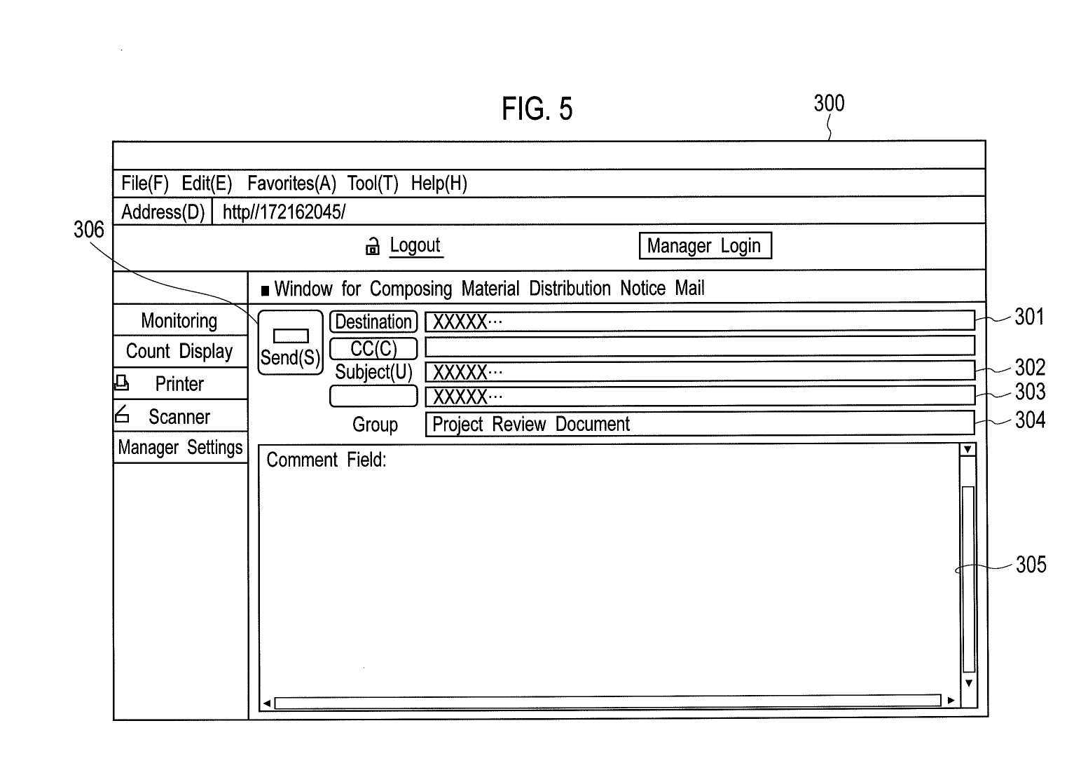

FIG. 5 is a diagram illustrating an example of the compose mail window 300 displayed on the screen of the terminal 2A.

As illustrated in FIG. 5, the compose mail window 300 includes a destination mail address field 301 to display an inputted destination mail address, a subject input field to display an inputted subject of the mail, an attached file field 303 to display the name of an attached file, a group display field 304 to display a selected group, a comment input field 305 to display a comment inputted by the user, and a send button 306 to be pressed to send the mail.

Returning FIG. 4, user operations in steps S111 to S119 are described. Note that the operations in steps S111 to S117 may be performed in random order.

Firstly, the user inputs a destination mail address into the destination mail address field 301 of the compose mail window 300 (step S111).

Next, the user inputs a subject of the mail into the subject input field 302, inputs a comment into the comment input field 305 (step S113), and attaches a file desired to be sent to the attached file field 303 (step S115).

Then, the user selects a group from the group display field 304 (step S117).

Here, in the group display field 304, group names are displayed in a pull-down menu form, and then after the user selects one of the displayed group names, the selected group name is displayed.

In the example illustrated in FIG. 5, two group names of the “project A review document” and the “internal notice on general information sharing” are displayed in the pull-down menu form and the “project A review document” is selected and displayed from these two group names.

Next, the user presses down the send button 306 (step S119).

When the send button 306 is pressed down in step S119, the terminal 2A judges weather the destination mail address and the group are designated (step S121).

When the destination mail address and the group are judged as not being designated in step S121 (in the case of NO), the terminal 2A displays an error message (step S125).

On the other hand, when the destination mail address and the group are judged as designated in step S121 (in the case of YES), the terminal 2A sends the mail to the print job management apparatus 3 (step S123).

### Print Job Generation Process

The print job generation process in the image formation system 1 is described.

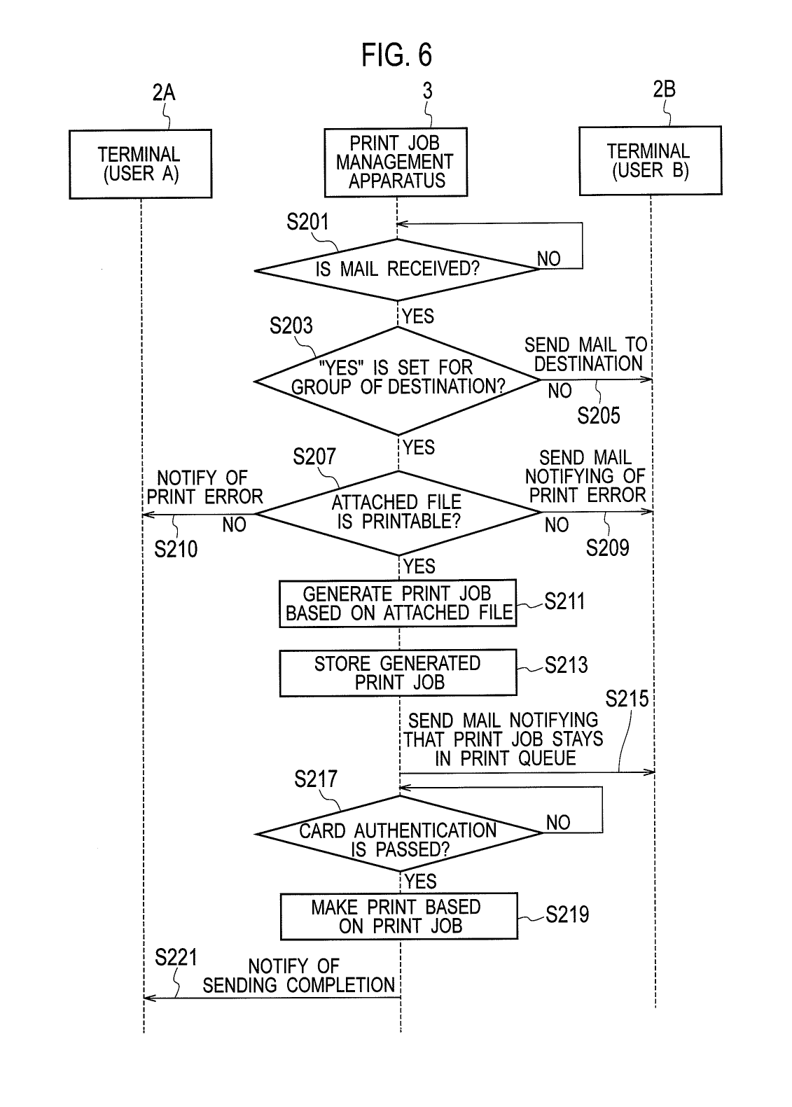

FIG. 6 is a sequence diagram illustrating a processing procedure of the print job generation process in the image formation system 1. The description herein is provided by using an example where the user A operating the terminal 2A sends a mail via the print job management apparatus 3 to the user B operating the terminal 2B. In this example, the user A logs in from the terminal 2A and the user B logs in from the terminal 2B.

As illustrated in FIG. 6, when the print job management apparatus 3 receives a mail sent from the terminal 2A (step S201: YES), the judgment section 32 of the controller 30 judges whether or not “YES” is set for the designated group associated with the mail address of the destination user (step S203). More specifically, the judgment section 32 judges whether the attached file needs to be printed or not for the user designated as the mail destination based on the user information stored in the user information storage section 51 of the storage 50.

For example, if the mail address of the destination user B is “hanako@XXX.co.jp” and the designated group is the “project A review document,” the judgment section 32 judges that the printing is needed in the example of the user information in FIG. 2, because the “project A review document” associated with “hanako@XXX.co.jp” is set to “YES”.

If it is judged that the designated group associated with the mail address of the destination user is set to “NO” in step S203 (in the case of NO), the sending section 34 sends the mail to the mail address of the destination (step S205). Here, the print job management apparatus 3 sends the mail received in step S201 to the terminal 2B from which the user B logs in.

In this way, when the group is set in advance to “NO” by a user who does not require the printing, the print job management apparatus 3 transfers the mail without making printout.

On the other hand, if it is judged the designated group associated with the mail address of the destination user is set to “YES” in step S203 (in the case of YES), then the judgment section 32 judges whether the attached file is printable or not (step S207). Specifically, the judgment section 32 performs an error check on whether the attached file is broken, or has any other trouble.

If it is judged that the attached file is not printable in step S207 (in the case of NO), the sending section 34 sends the mail sent from the sender and also a mail notifying of a print error to the mail address of the destination (step S209). For example, the sending section 34 of the print job management apparatus 3 sends a mail having a comment text such as “Printing of the file sent to you from the user A is failed” to the terminal 2B from which the user B logs in.

Moreover, the sending section 34 also sends a mail notifying of the print error to the mail address of the sender (step S210). For example, the print job management apparatus 3 sends a mail having a comment text such as “Printing of the file attached to the mail sent to the user B is failed” to the terminal 2A from which the user A logs in.

On the other hand, if it is judged that the attached file is printable in step S207 (in the case of YES), the generation section 33 generates a print job based on the attached file (step S211) and stores the generated print job in the print job storage section 52 of the storage 50 (step S213).

Then, the sending section 34 sends the mail sent from the sender and also a mail notifying that the print job stays in the print queue to the mail address of the destination user (step S215). For example, the sending section 34 of the print job management apparatus 3 sends a mail having a comment text such as “The print job stays in the print queue. Please conduct an output operation on the printer with your authentication card” to the terminal 2B from which the user B logs in.

Next, the authentication unit 31 judges whether card authentication is passed or not with the authentication card (step S217). Specifically, the authentication unit 31 judges whether the user performs operations of selecting the print job displayed on the display-input panel of the console 40; causing the card reader 71 to read the user ID corresponding to this print job; and inputting the password into the display-input panel of the console 40.

Then, when judging that the password is inputted, the authentication unit 31 judges whether the user ID and the password match the user ID and the password in the user authentication information stored in the user information storage section 51 of the storage 50.

When it is judged that the card authentication is passed in step S217 (in the case of YES), the printer 60 performs print processing based on the print job (step S219). Specifically, the printer 60 makes color print on a print medium cut in a predetermined size on the basis of the print job by ejecting inks of totally four colors of cyan (c), magenta (M), yellow (Y) and black (K) from the inkjet heads of the four colors.

When a user who desires to print out an attached file sets “YES” for the corresponding group in advance, the print job management apparatus 3 automatically prints out the file. Thus, the user can obtain the printout without performing bothering manual operations to cause the print processing to run.

Then, the sending section 34 sends a mail notifying of sending completion to the mail address of the sender user (step S221). For example, the sending section 34 of the print job management apparatus 3 sends a mail having a comment text such as “Printing of the file attached to the mail sent to the user B is completed normally” to the terminal 2A from which the user A logs in.

As described above, the print job management apparatus 3 included in the image formation system 1 according to the embodiment of the present invention includes: the sending section 34 configured to receive a mail including the address of a destination user, an attached file and the group identification information identifying the group to which the attached file belongs, and send the mail to the destination user; the user information storage section 51 in which the user address and the print necessity flags for the respective groups based on the group identification information are stored in association with each other as the user information for each user, the print necessity flags each indicating whether an attached file belonging to the corresponding group needs to be printed or not; the judgment section 32 configured to judge whether the attached file needs to be printed or not for a user designated as the mail destination based on the user information; and the generation section 33 that generates a print job of the attached file for the user judged as requiring the printing by the judgment section 32. Thus, the print job management apparatus 3 allows the reading style to be changed depending on each user.

It should be noted that, although the embodiment of the present invention judges whether an attached file belonging to a group associated with a user designated as a mail destination needs to be printed or not, an embodiment of the present invention may be implemented in another way.

For example, a judgment may be made on whether an attached file for a user designated as a mail destination needs to be printed or not.

To be more specific, in another embodiment of the present invention, a print job management apparatus may include a sending section configured to receive a mail including the address of a destination user and an attached file, and send the mail to the destination user; a user information storage section in which the address and a print necessity flag indicating whether the attached file needs to be printed or not are stored in association with each other as user information for each user; a judgment section configured to judge whether the attached file needs to be printed or not for the user designated as the mail destination on the basis of the user information; and a job generation section configured to generate a print job of the attached file for the user judged as requiring the printing by the judgment section.

In addition, the embodiment is described by using as an example the image formation system including the print job management apparatus 3 of inkjet-type. However, an embodiment is not limited to this, but may include any of various types of print job management apparatuses such as laser-print-type and screen-print-type.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A print job management apparatus comprising:
a sending section configured to receive a mail including an address of a user designated as a destination and an attached file, and send the mail to the user designated as the destination;
a user information storage section configured to store therein the address and a print necessity flag indicating whether the attached file needs to be printed in association with each other as user information for each user;
a judgment section configured to judge whether the attached file needs to be printed for the user designated as the destination of the mail on a basis of the user information stored in the user information storage section; and
a job generation section configured to generate a print job of the attached file for the user judged as requiring a printing of the attached file by the judgment section.

2. A print job management apparatus comprising:
a sending section configured to receive a mail including an address of a user designated as a destination, an attached file, and group identification information identifying a group to which the attached file belongs, and send the mail to the user designated as the destination;
a user information storage section configured to store therein the address and a print necessity flag in association with each other as user information for each user, the print necessity flag indicating whether an attached file belonging to the group needs to be printed for each group identified by the group identification information;
a judgment section configured to judge whether the attached file needs to be printed for the user designated as the mail destination on a basis of the user information stored in the user information storage section; and
a job generation section configured to generate a print job of the attached file for the user judged as requiring a printing of the attached file by the judgment section.
